(19) United States
(12) Patent Application Publication
(10) Pub. No.: US 2026/0199882 A1
(43) Pub. Date: Jul. 16, 2026

(54) MESOPOROUS MOLECULAR SIEVE-BASED SOLID ACID-BASE CATALYST, AND PREPARATION METHOD AND USE THEREOF IN SYNTHESIS OF INSULATING OIL FOR TRANSFORMER

(71) Applicants: SHANDONG UNIVERSITY OF TECHNOLOGY, Zibo (CN); SHANDONG LUKONG ELECTRIC POWER EQUIPMENT CO., LTD, Dezhou (CN)

(72) Inventors: Shuguang ZHANG, Zibo (CN); Zongjun XIN, Dezhou (CN); Manman ZHAO, Zibo (CN); Xin XIN, Dezhou (CN); Long WANG, Zibo (CN); Yawen ZHANG, Zibo (CN); Xingyu CHEN, Zibo (CN); Hongzheng LIU, Dezhou (CN); Yong LI, Dezhou (CN); Yang YANG, Dezhou (CN)

(21) Appl. No.: 19/135,234

(22) PCT Filed: Jan. 4, 2024
(86) PCT No.: PCT/CN2024/070549

§ 371 Date: Jun. 3, 2025

(30) Foreign Application Priority Data
Apr. 20, 2023 (CN) 202310424569.X

(51) Int. Cl. B01J 29/04; B01J 35/61; B01J 35/63; B01J 35/64; B01J 37/00; B01J 37/02; B01J 37/08

(52) U.S. Cl. CPC B01J 29/041; B01J 35/617; B01J 35/635; B01J 35/651; B01J 37/0018; B01J 37/0201; B01J 37/08

(57) ABSTRACT

A mesoporous molecular sieve-based solid acid-base catalyst and a preparation method and use thereof in synthesis of an insulating oil for a transformer are provided. The preparation method of the mesoporous molecular sieve-based solid acid-base catalyst includes the following steps: synthesizing a hard template, preparing a catalyst skeleton, preparing a precursor, and preparing a solid acid-base catalyst.

### CROSS REFERENCE TO RELATED APPLICATIONS

The present application is a national stage application of International Patent Application No. PCT/CN2024/070549, filed on Jan. 4, 2024, which claims priority to the Chinese Patent Application No. 202310424569.X, filed with the China National Intellectual Property Administration (CNIPA) on Apr. 20, 2023, and entitled “USE OF MESOPOROUS MOLECULAR SIEVE-BASED SOLID ACID-BASE CATALYST IN SYNTHESIS OF INSULATING OIL FOR TRANSFORMER,” both of which are incorporated herein by reference in their entireties.

### TECHNICAL FIELD

The present disclosure belongs to the technical field of insulating oil preparation, and specifically relates to a mesoporous molecular sieve-based solid acid-base catalyst, and a preparation method and use thereof in synthesis of an insulating oil for a transformer.

### BACKGROUND

Insulating oil is generally prepared by adding an antioxidant to a deeply refined base oil of lubricating oil, and is widely used in high-voltage power equipment such as transformers, circuit breakers, oil-filled cables, power capacitors, and bushings. The insulating oil impregnates and protects transformers, cables, and capacitors by preventing the ingress of air or moisture to ensure reliable insulation. The insulating oil also plays a cooling role on power equipment such as the transformers, where a hot oil is cooled by the radiator and then returned to the transformer body, such that the insulating oil is circulated and cooled in the transformer box to keep the transformer temperature within a certain range. The insulating oil not only acts as an insulating medium, but also as an arc extinguishing medium to prevent the arc from spreading and to cause the arc to be extinguished quickly.

The insulating oil for transformers can be mainly divided into several categories, such as mineral insulating oil, vegetable insulating oil, silicone insulating oil, synthetic ester insulating oil, and modified insulating oil. However, the mineral insulating oil is prone to leakage pollution and has poor fire resistance; the silicone insulating oil, the synthetic ester insulating oil, and the modified insulating oil have high manufacturing costs. Therefore, the vegetable insulating oil is becoming increasingly a research hotspot in the industry.

At present, the preparation of vegetable insulating oil is mainly based on raw materials such as rapeseed oil and camellia oil, while there are few studies using cottonseed oil as a raw material. In addition, the acid value and other indicators of the cottonseed oil are relatively high, and the use of a single base catalyst cannot avoid problems such as active site poisoning in the transesterification.

Chinese patent CN106635432A discloses a method for producing a vegetable insulating oil using a swill oil. Refined swill oil is used as a main raw material, a reaction raw material is ethanol, a catalyst is KOH or NaOH, and a neutralizing agent is phosphoric acid. The refined swill oil and the ethanol are transesterified to reduce viscosity of the swill oil, and remove impurities in the swill oil to obtain high-purity fatty acid ethyl ester. Then the fatty acid ethyl ester is used as a main raw material, a reaction raw material is pentaerythritol, a catalyst is monobutyl tin oxide, a filter agent includes diatomaceous earth, white clay, and activated carbon, and nitrogen is used as a protective gas. Through a reaction of the fatty acid ethyl ester and the pentaerythritol, a high-quality vegetable insulating oil is prepared through refining.

Chinese patent CN113817525A discloses a preparation method of a natural ester insulating oil. A raw oil including a recovered oil is degummed to remove phospholipids to reduce the influence of the phospholipids on a pour point, which is simultaneously conducive to promoting the subsequent separation of fatty acids of each component. Then a degummed raw oil is subjected to transesterification. After the removal of impurities, mixed fatty acid monoesters are obtained, which are then subjected to solvent crystallization and separation to obtain various high-purity single-component fatty acid monoesters. The high-purity single-component fatty acid monoesters are subjected to transesterification with glycerol under the action of a catalyst to obtain various corresponding high-purity single-component triglycerides. After mixing, the natural ester insulating oil with a low pour point and condensation point is obtained, which can be used at low-temperature areas, and has a low kinematic viscosity, desirable fluidity, and high heat dissipation capacity.

In the above patents, a single base catalyst is adopted to conduct transesterification, but the single base catalyst is sensitive to the acid value and water content of the raw oil, resulting in separation difficulties.

### SUMMARY

The present disclosure is to provide a mesoporous molecular sieve-based solid acid-base catalyst, and a preparation method and use thereof in synthesis of an insulating oil for a transformer. The mesoporous molecular sieve-based solid acid-base catalyst synthesised by the present disclosure has the advantages such as high activity, long performance retention life, and no requirement for an acid value of the raw material, and can be used in the synthesis of the insulating oil for the transformer by transesterification of a cottonseed oil.

To achieve the above objects, the present disclosure provides the following technical solutions:

The present disclosure provides a method for preparing a mesoporous molecular sieve-based solid acid-base catalyst, including:
(1) synthesizing a hard template
mixing a polymer monomer and a first pure water to obtain a polymer monomer aqueous solution, subjecting the polymer monomer aqueous solution, and an initiator to a first reaction while stirring under protection of an inert gas to obtain a nanosphere, and washing and drying the nanosphere to obtain a nanosphere hard template I;
(2) preparing a catalyst skeleton
stirring a soft template, a nitrate, a silane derivative, and a second pure water to obtain a precursor II, mixing the nanosphere hard template I and the precursor II, and subjecting a resulting material to aging to obtain a catalyst skeleton III;
(3) preparing a precursor
leaching the catalyst skeleton III with a solvent to remove the nanosphere hard template I to obtain a catalyst precursor IV without the nanosphere hard template I, subjecting the catalyst precursor IV, an organic solvent, and a transition metal alkoxy compound to a second reaction while stirring under protection of an inert gas, subjecting a resulting reaction product to first vacuum filtration to obtain a filter cake, drying the filter cake, then hydrolysing, and then subjecting a resulting hydrolysied product to second vacuum filtration and first drying to obtain a powder precursor V; and
(4) preparing a solid acid-base catalyst
impregnating the powder precursor V with an ammonium persulfate solution, and subjecting a resulting system to third vacuum filtration, second drying, and calcination in sequence to obtain the mesoporous molecular sieve-based solid acid-base catalyst.

In some embodiments, in step (1), raw materials of the nanosphere hard template I further comprise a modified dispersant.

In some embodiments, in step (2), raw materials of the precursor II further comprise a pore expanding agent.

In some embodiments, in step (1), the polymer monomer is one or two selected from the group consisting of 4-methylstyrene, 1-ethylene-4-(2-methylpropyl)benzene, 4-tert-butylstyrene, and vinyl acetate.

In some embodiments, in step (1), a mass ratio of the polymer monomer to the first pure water is in a range of 1:5 to 1:9.

In some embodiments, in step (1), the modified dispersant is 2-acrylamide-2-methylpropanesulfonic acid.

In some embodiments, in step (1), a dosage of the modified dispersant is 0% to 1% of a total mass of the polymer monomer.

In some embodiments, in step (1), the initiator is selected from the group consisting of a single initiator and a redox composite initiator; the single initiator is selected from the group consisting of H₂O₂, ammonium persulfate, and potassium persulfate; the redox composite initiator is selected from the group consisting of a persulfate-sodium sulfite system composite initiator, a persulfate-sodium bisulfite system composite initiator, a persulfate-sodium dithionate system composite initiator, a persulfate-vitamin C system composite initiator, a H₂O₂-sodium sulfite system composite initiator, a H₂O₂-sodium bisulfite system composite initiator, a H₂O₂-sodium dithionate system composite initiator, and a H₂O₂-vitamin C system composite initiator; and a persulfate in the redox composite initiator is selected from the group consisting of the ammonium persulfate and the potassium persulfate.

In some embodiments, in step (1), a dosage of the initiator is 0.5% to 6% of a total mass of the polymer monomer.

In some embodiments, in step (1), the first reaction under the stirring is conducted at a temperature of 50° C. to 80° C.

In some embodiments, in step (1), the washing is conducted 3 to 4 times, and the drying is conducted at a temperature of 80° C. to 100° C.

In some embodiments, in step (2), the soft template is a polyoxyethylene nonionic surfactant; and the polyoxyethylene nonionic surfactant is one or two selected from the group consisting of a long-chain alkyl secondary alcohol polyoxyethylene ether series surfactant (CₘH₂ₘ₊₁ O(C₂H₄O) ₙH, m=11-15, n=3, 5, 7, 9, 12, 15, 20, 30, 40) and an alkyl aryl polyoxyethylene ether series surfactant (C₈H₁₇—C₆H₄—O(C₂H₄O)ₙH, n=3, 4.5, 7.5, 9.5, 12).

In some embodiments, in step (2), the nitrate is one or more selected from the group consisting of a Group II metal nitrate and a rare earth metal nitrate, such as Ca(NO₃)₂·4H₂O, Mg(NO₃)₂·6H₂O, La(NO₃)₃·6H₂O, and Ce(NO₃)₃·6H₂O.

In some embodiments, in step (2), the silane derivative is one or more selected from the group consisting of tetramethoxysilane (TMOS), tetraethoxysilane (TEOS), tetrapropoxysilane (TPOS), and tetrabutoxysilane (TBOS).

In some embodiments, in step (2), the pore expanding agent is one or two selected from the group consisting of mesitylene, a straight-chain alkane, and tert-amyl alcohol, and a molar ratio of the pore expanding agent to the soft template is in a range of 0:1 to 1:1.

In some embodiments, in step (2), a molar ratio of the soft template, the nitrate, the silane derivative, and the second pure water is in a range of 1:2-8:14-31:400-500.

In some embodiments, in step (2), the stirring is conducted at room temperature to 55° C., preferably 40° C. to 45° C., for 15 min to 60 min with a stirring speed of 800 rpm to 1,200 rpm.

In some embodiments, in step (2), a mass ratio of the nanosphere hard template I to the precursor II is in a range of 2:3 to 2:5.

In some embodiments, in step (2), the mixing is conducted for 20 min to 30 min, and the aging is conducted for 36 h to 96 h.

In some embodiments, in step (3), the solvent is selected from the group consisting of methyl ethyl ketone, ethyl acetate, and toluene.

In some embodiments, in step (3), a mass ratio of the catalyst skeleton III to the solvent is in a range of 1:5 to 1:8.

In some embodiments, in step (3), the leaching is conducted at a temperature of −3° C. to 5° C. for 15 s to 30 s.

In some embodiments, in step (3), the organic solvent is selected from the group consisting of isooctane, heptane, isobutanol, n-butanol, butyl acetate, toluene, p-xylene, propanol, and methyl isobutyl ketone.

In some embodiments, in step (3), the transition metal alkoxy compound is selected from the group consisting of a zirconium alkoxy compound, a titanium alkoxy compound, and a hafnium alkoxy compound, and an alkoxy in the transition metal alkoxy compound is selected from the group consisting of tetraethoxy, tetrapropoxy, tetraisopropoxy, and tetrabutoxy.

In some embodiments, in step (3), a mass ratio of the catalyst precursor IV to the organic solvent is in a range of 1:14 to 1:24, and a mass ratio of the transition metal alkoxy compound to the catalyst precursor IV is in a range of 1:1 to 1:2.

In some embodiments, in step (3), the second reaction while the stirring is conducted at a temperature of 60° C. to 80° C. for 24 h to 36 h.

In some embodiments, in step (4), the ammonium persulfate solution has a concentration of 1 mol/L to 2 mol/L.

In some embodiments, in step (4), the impregnating is conducted for 4 h to 8 h.

In some embodiments, in step (4), the calcination is conducted at a temperature of 400° C. to 600° C. for 4 h to 8 h.

In some embodiments, the method for preparing the mesoporous molecular sieve-based solid acid-base catalyst includes the following steps:

### (1) Synthesizing a Hard Template

A polymer monomer after removing a polymerization inhibitor, and a first pure water are mixed to obtain a polymer monomer aqueous solution. The polymer monomer aqueous solution and a modified dispersant (whether to add depends on whether a block hard template is to be synthesised) are added to a reaction device equipped with an inert gas protection system and a stirrer, and an initiator is added dropwise thereto, while stirring a resulting mixture at a certain temperature to polymerize the resulting mixture into a nanosphere. The nanosphere is subjected to high-speed centrifugation, washing, and drying to obtain a nanosphere hard template I.

In some embodiments of the present disclosure, the stirring is conducted at a speed of 200 rpm to 800 rpm, the dropwise addition of the initiator is conducted for 30 min to 60 min, and the centrifugation is conducted at a speed of 10,000 rpm to 20,000 rpm.

In some embodiments of the present disclosure, under the condition that the modified dispersant is added during the synthesis of the block hard template, a molar ratio of the polymer monomer aqueous solution to the modified dispersant is in a range of 1:5 to 5:1.

### (2) Preparing a Catalyst Skeleton

A soft template, a nitrate, a silane derivative, and a pore expanding agent (whether to add or not depends on the desired pore size) are added to a second pure water in a proportion, a resulting material is put into a stirring mixer, and then mixed evenly at a certain temperature to obtain a precursor II. Related groups in a molecular structure of the soft template self-assemble to form micelles through hydrogen bonding and hydrophilic-hydrophobic interactions with water molecules, the nitrate is wrapped inside the micelles, and the silane derivative forms a three-dimensional MCM-type mesoporous silicon-oxygen network structure outside the micelles after hydrolysis.

The nanosphere hard template I synthesized in step (1) and the precursor II are stirred in a proportion for 20 min to 30 min to achieve homogenization, a resulting system is subjected to rotary evaporation to remove hydrolyzed small-molecule products and a resulting residual product is subjected to gelation aging in air at room temperature for 36 h to 96 h to obtain a catalyst skeleton III.

### (3) Preparing a Precursor

The catalyst skeleton III is leached with a solvent at low temperature (−3° C. to 5° C.) at a stirring speed of 500 rpm to 1,000 rpm for 15 s to 30 s, and a resulting material is subjected to first vacuum filtration to obtain a filter cake, the filter cake is washed 3 times with a solvent at low temperature. The leaching is repeated 3 to 4 times to remove the nanosphere hard template I to obtain a catalyst precursor IV without the nanosphere hard template I. The catalyst precursor IV, an organic solvent, and a transition metal alkoxy compound are added to a device equipped with an inert gas protection system and a stirrer, and subjected to a reaction while stirring at a temperature of 60° C. to 80° C. for 24 h to 36 h. A resulting reaction product is subjected to second vacuum filtration to obtain a filter cake, and the filter cake is dried, then hydrolyzed at a stirring speed of 500 rpm to 1,000 rpm for 2 h to 4 h, and then a resulting hydrolyzed product is subjected to third vacuum filtration and then drying for 6 h to obtain a powder precursor V.

### (4) Preparing the Mesoporous Molecular Sieve-Based Solid Acid-Base Catalyst

The powder precursor V is impregnated with an ammonium persulfate solution at room temperature at a stirring speed of 500 rpm to 1,000 rpm for 4 h to 8 h, and a resulting system is subjected to fourth vacuum filtration to obtain a filter cake, the filter cake is subjected to vacuum drying at 90° C. for 4 h and calcination at a temperature of 400° C. to 600° C. for 4 h to 8 h to remove the soft template therein to obtain the mesoporous molecular sieve-based solid acid-base catalyst.

The present disclosure further provides a mesoporous molecular sieve-based solid acid-base catalyst prepared by the method as described in the above technical solutions, where the mesoporous molecular sieve-based solid acid-base catalyst is a topological structure in which macropores and mesopores are interconnected; the macropores are located on a surface of the catalyst, and the mesopores are located inside the catalyst; an acidic site exists in the macropores, and a basic site exists in the mesopores; and the acidic site and the basic site are confined and separated from each other in space.

The present disclosure further provides use of a mesoporous molecular sieve-based solid acid-base catalyst in synthesis of an insulating oil for a transformer, where the mesoporous molecular sieve-based solid acid-base catalyst is used in the synthesis of the insulating oil for the transformer by transesterification of a cottonseed oil; and the mesoporous molecular sieve-based solid acid-base catalyst is the mesoporous molecular sieve-based solid acid-base catalyst as described in the above technical solutions.

The present disclosure provides a mesoporous molecular sieve-based solid acid-base catalyst. In the present disclosure, the soft template used is a polyoxyethylene nonionic surfactant. Related groups in a molecular structure of the soft template self-assemble to form micelles through hydrogen bonding and hydrophilic-hydrophobic interactions with water molecules, the nitrate is wrapped inside the micelles, and the silane derivative forms a three-dimensional MCM-type mesoporous silicon-oxygen network structure outside the micelles after hydrolysis. Then, the soft template is removed by high-temperature calcination, and the nitrate is decomposed to generate metal oxides which are attached to the inside of pores in MCM-type mesoporous silica. Table 2 and FIG. 2 show that a mesopore diameter of the catalyst of the present disclosure is about 4 nm to 5 nm; from a wide-angle X-ray diffraction pattern in FIG. 1B, it can be seen that the metal oxides exist in the mesopores in an amorphous non-crystalline state and are highly dispersed.

On the other hand, when the prepared catalyst skeleton III is subjected to solvent leaching to remove the nanosphere hard template I, a large number of open macroporous structures are formed on the surface of the material, and then the transition metal alkoxy compound is hydrolyzed and loaded into these macroporous structures, and then immersed in the ammonium persulfate solution and calcined to obtain a persulfate-activated macroporous solid acid material.

The present disclosure further provides a mesoporous molecular sieve-based solid acid-base catalyst prepared by the method as described in the above technical solutions. The MCM-type mesoporous molecular sieve-based solid acid-base catalyst is a topological structure in which macropores and mesopores are interconnected; the macropores are located on a surface of the catalyst, and the mesopores are located inside the catalyst; an acidic site exists in the macropores, and a basic site exists in the mesopores; and the acidic site and the basic site are confined and separated from each other in space.

When high-acidity raw oil enters from the macropores on the surface, most of free oleic acid is esterified at the acidic sites of this structure, and then migrates along the channels between the macropores and mesopores into the MCM mesopores, where the transesterification occurs. This topological spatial separation of different functional active sites effectively prevents the free oleic acid from poisoning the basic active sites.

The present disclosure further provides use of the mesoporous molecular sieve-based solid acid-base catalyst as described in the above technical solutions in synthesis of an insulating oil for a transformer. In the present disclosure, the mesoporous molecular sieve-based solid acid-base catalyst can be used for the synthesis of the insulating oil of the transformer.

In the present disclosure, the synthesised mesoporous molecular sieve-based solid acid-base catalyst has a topological spatial separation of basic and acidic active sites, thereby effectively preventing free fatty acids from poisoning the basic active sites, reducing a grade requirement of raw materials, greatly expanding a source of the raw materials, and reducing a cost of synthesizing the insulating oil for the transformer.

### BRIEF DESCRIPTION OF THE DRAWINGS

To illustrate the technical solutions in examples of the present disclosure or in the prior art more clearly, the drawings required for the examples are briefly described below. Apparently, the drawings in the following description are merely some examples of the present disclosure, and those of ordinary skill in the art may still obtain other drawings from these drawings without creative efforts.

FIG. 1A to FIG. 1B show X-ray diffraction (XRD) patterns of the MCM-type mesoporous molecular sieve-based solid acid-base catalyst prepared in Example 1, where FIG. 1A shows a small-angle XRD pattern, and FIG. 1B shows a wide-angle XRD pattern.

FIG. 2 shows a pore size distribution of the MCM-type mesoporous molecular sieve-based solid acid-base catalyst prepared in Example 1.

FIG. 3 shows an N₂ physical adsorption-desorption isotherm curve of the MCM-type mesoporous molecular sieve-based solid acid-base catalyst prepared in Example 1.

### DETAILED DESCRIPTION OF THE EMBODIMENTS

In order to further illustrate the present disclosure, the technical solutions provided by the present disclosure are described in detail below with reference to the drawings and examples, but these examples should not be understood as limiting the claimed scope of the present disclosure.

In the present disclosure, cottonseed oil is used as a raw material, and a cottonseed oil derivative insulating oil having a high flash point and ignition point as well as desirable low-temperature performance is prepared by transesterification between the cottonseed oil and a long-chain branched alcohol, and the selected long-chain branched alcohol is isotridecanol. Two representative cottonseed oils are selected for use in the examples, and are named cottonseed oil I (low acid value) and cottonseed oil II (high acid value), respectively. Their compositions and parameters are shown in Table 1.

Table 1 Composition of cottonseed oil used in examples

| | Item | |
|---|---|---|
| | Cottonseed oil I | Cottonseed oil II |
| | (low acid value) | (high acid value) |
| | Color | |
| | Orange-yellow, | Orange-yellow, |
| | transparent | transparent |
| Relative density | 0.92 | 0.915 |
| Moisture (%) | 0.2 | 0.16 |
| Acid value (based on KOH, mg/g) | 1.0 | 33.26 |
| Insoluble impurities (wt %) | 0.2 | 0.16 |
| Saturated fatty acid ester | 26.3 | 21.92 |
| composition (wt %) | | |
| Palmitate (C16:0) | 22.5 | 18.75 |
| Stearate (C18:0) | 2.5 | 2.08 |
| Myristate (C14:0) | 0.6 | 0.50 |
| Arachidate (C20:0) | 0.5 | 0.42 |
| Behenate (C22:0) | 0.2 | 0.17 |
| Monounsaturated fatty acid | 19.8 | 16.50 |
| ester composition (wt %) | | |
| Oleate (C18:1) | 18.9 | 15.75 |
| Palmitoleate (C16:1) | 0.8 | 0.67 |
| Erucate (C22:1) | 0.1 | 0.08 |
| Polyunsaturated fatty acid | 53.5 | 44.59 |
| ester composition (wt %) | | |
| Linoleate (C18:2) | 53.3 | 44.42 |
| Linolenate (C18:3) | 0.2 | 0.17 |
| Oleic acid (wt %) | — | 16.67 |

### Example 1

A polymer monomer 1-ethylene-4-(2-methylpropyl)benzene after removing a polymerization inhibitor, and pure water were mixed to obtain a 1-ethylene-4-(2-methylpropyl)benzene aqueous solution (11.1%, w/w). 900 g (11.1%, w/w) of the 1-ethylene-4-(2-methylpropyl)benzene aqueous solution was added to a reaction device equipped with an inert gas protection system and a stirrer, and an initiator (H₂O₂-vitamin C redox system) was added dropwise thereto while stirring (at 600 rpm) a resulting mixture at 70° C., where amounts of the dropwise addition of H₂O₂ and vitamin C were 2% and 0.5% of a mass of the polymer monomer, respectively, and the dropwise addition was conducted for a total of 50 min. After the initiator was added dropwise, the stirring speed was adjusted to 300 rpm. After forming a polymer nanosphere, a resulting system was stirred continually for 12 h, and then subjected to high-speed centrifugation at 20,000 rpm, washing 3 times, and vacuum drying at 100° C. to obtain a nanosphere hard template I.

15.2 g of a soft template long-chain alkyl secondary alcohol polyoxyethylene ether CₘH₂ₘ₊₁O(C₂H₄O)ₙH (where m=12, n=30), 20.4 g of Mg(NO₃)₂·6H₂O, and 45 mL of TMOS were added to 90 g of pure water. A resulting mixture was put into a stirring mixer, and mixed by stirring at 45° C. and 1,000 rpm for 60 min to obtain a precursor II.

20 g of the nanosphere hard template I and 50 g of the precursor II were mixed, and stirred for 20 min to achieve homogenization. A resulting material was subjected to rotary evaporation to remove hydrolyzed small-molecule products, and a resulting residual product was subjected to gelation aging in air at room temperature for 72 h to obtain a catalyst skeleton III.

30 g of the catalyst skeleton III was leached with 178 mL of toluene at low temperature (−3° C.) at a stirring speed of 800 rpm for 20 s, and a resulting material was subjected to vacuum filtration to obtain a filter cake, and the filter cake was washed 3 times with cold toluene at low temperature. The leaching was repeated 3 times to remove the nanosphere hard template I to obtain a catalyst precursor IV without the nanosphere hard template I.

8 g of the catalyst precursor IV, 198 mL of n-butanol, and 4 g of tetrabutoxyzirconium were added to a device equipped with an inert gas protection system and a stirrer, and subjected to a reaction while stirring at 80° C. for 24 h. A resulting reaction product was subjected to vacuum filtration to obtain a filter cake, and the filter cake was dried, then hydrolyzed at a stirring speed of 800 rpm for 4 h, and then a resulting hydrolyzed product was subjected to vacuum filtration and then drying for 6 h to obtain a powder precursor V.

The powder precursor V was impregnated with 1.5 mol/L of an ammonium persulfate solution at room temperature at a stirring speed of 1,000 rpm for 8 h. A resulting system was subjected to vacuum filtration to obtain a filter cake, and the filter cake was subjected to vacuum drying at 90° C. for 4 h, and then calcined at 400° C. for 6 h to remove the soft template therein to obtain an MCM-type mesoporous molecular sieve-based solid acid-base catalyst of “mesoporous MgO-macroporous ZrO₂/S₂O₈²⁻”.

30 g of cottonseed oil I (acid value of 1.0), 250 mL of isotridecanol, and 3.9 g of the MCM-type mesoporous molecular sieve-based solid acid-base catalyst of “mesoporous MgO-macroporous ZrO₂/S₂O₈²⁻” were added to a reaction device equipped with an inert gas protection system and a stirrer, and a resulting mixture was heated to 80° C. while stirring (at 800-1000 rpm) then subjected to a reaction for 4 h. After that, the catalyst was removed by filtration, and a resulting filtrate was stood and layered, where an upper layer mainly consisted of fatty acid isotridecyl ester and isotridecanol, while a lower layer mainly consisted of glycerol and isotridecanol. The isotridecanol in the upper oil phase was recovered by molecular distillation, and the fatty acid isotridecyl ester product was refined by unit operations, such as adsorption decolorization, and filtration.

### Example 2

A polymer monomer 4-tert-butylstyrene after removing a polymerization inhibitor, and pure water were mixed to obtain a 4-tert-butylstyrene aqueous solution (14.3%, w/w). 798 g (14.3%, w/w) of the 4-tert-butylstyrene aqueous solution was added to a reaction device equipped with an inert gas protection system and a stirrer, and an initiator (potassium persulfate-sodium sulfite redox system) was added dropwise thereto while stirring (at 800 rpm) a resulting mixture at 50° C., where amounts of the dropwise addition of potassium persulfate and sodium sulfite were 4% and 1% of a mass of the polymer monomer, respectively, and the dropwise addition was conducted for a total of 60 min. After the initiator was added dropwise, the stirring speed was adjusted to 400 rpm. After forming a polymer nanosphere, a resulting system was stirred continually for 18 h, and then subjected to high-speed centrifugation at 15,000 rpm, washing 4 times and vacuum drying at 80° C. to obtain a nanosphere hard template I.

6.24 g of a soft template alkyl aryl polyoxyethylene ether C₈H₁₇-C₆H₄—O(C₂H₄O) 9.5H, 1.2 g of mesitylene, 9.4 g of Ca(NO₃)₂·4H₂O, and 58 mL of TPOS were added to 72 g of pure water. A resulting mixture was put into a stirring mixer, and mixed by stirring at 35° C. and 800 rpm for 15 min to obtain a precursor II.

20 g of the nanosphere hard template I and 30 g of the precursor II were mixed, and stirred for 30 min to achieve homogenization. A resulting material was subjected to rotary evaporation to remove hydrolyzed small-molecule products, and a resulting residual product was subjected to gelation aging in air at room temperature for 36 h to obtain a catalyst skeleton III.

30 g of the catalyst skeleton III was leached with 225 mL of methyl ethyl ketone at low temperature (0° C.) at a stirring speed of 600 rpm for 30 s, and a resulting material was subjected to vacuum filtration to obtain a filter cake, and the filter cake was washed 3 times with cold methyl ethyl ketone at low temperature. The leaching was repeated 3 times to remove the nanosphere hard template I to obtain a catalyst precursor IV without the nanosphere hard template I.

8 g of the catalyst precursor IV, 130 mL of butyl acetate, and 8 g of tetrabutoxytitanium were added to a device equipped with an inert gas protection system and a stirrer, and subjected to a reaction while stirring at 60° C. for 30 h. A resulting reaction product was subjected to vacuum filtration to obtain a filter cake, and the filter cake was dried, then hydrolyzed at a stirring speed of 600 rpm for 2 h, and then a resulting hydrolyzed product was subjected to vacuum filtration and then drying for 6 h to obtain a powder precursor V.

The powder precursor V was impregnated with 1 mol/L of an ammonium persulfate solution at room temperature at a stirring speed of 500 rpm for 6 h. a resulting system was subjected to vacuum filtration to obtain a filter cake, and the filter cake was subjected to vacuum drying at 90° C. for 4 h, and then calcined at 600° C. for 4 h to remove the soft template therein to obtain an MCM-type mesoporous molecular sieve-based solid acid-base catalyst of “mesoporous CaO-macroporous TiO₂/S₂O₈²⁻”.

The remaining steps were the same as those in Example 1.

### Example 3

151.2 g of a polymer monomer 4-methylstyrene after removing a polymerization inhibitor, 19 g of vinyl acetate, and 1,370 g of pure water were mixed to obtain a polymer monomer aqueous solution. The polymer monomer aqueous solution and 1.7 g of 2-acrylamide-2-methylpropanesulfonic acid were added to a reaction device equipped with an inert gas protection system and a stirrer, and an initiator (H₂O₂-sodium bisulfite redox system) was added dropwise thereto while stirring (at 400 rpm) a resulting mixture at 80° C., where amounts of the dropwise addition of H₂O₂ and sodium bisulfite were 3% and 0.75% of a mass of the polymer monomer, respectively, and the dropwise addition was conducted for a total of 30 min. After the initiator was added dropwise, the stirring speed was adjusted to 200 rpm. After forming a polymer nanosphere, a resulting system was stirred continually for 6 h, and then subjected to high-speed centrifugation at 10,000 rpm, washing 4 times and vacuum drying at 90° C. to obtain a segmented copolymer nanosphere hard template I.

4.3 g of a soft template long-chain alkyl secondary alcohol polyoxyethylene ether CₘH₂ₘ₊₁O(C₂H₄O)ₙH (where m=12, n=30), 4.43 g of alkyl aryl polyoxyethylene ether C₈H₁₇—C₆H₄—O(C₂H₄O) 9.5H, 5.12 g of Mg(NO₃)₂·6H₂O, and 50 mL of TBOS were added to 90 g of pure water. A resulting mixture was put into a stirring mixer, and mixed by stirring at 55° C. and 1,200 rpm for 30 min to obtain a precursor II.

16 g of the nanosphere hard template I and 40 g of the precursor II were mixed, and stirred for 25 min to achieve homogenization. A resulting material was subjected to rotary evaporation to remove hydrolyzed small-molecule products, and a resulting residual product was subjected to gelation aging in air at room temperature for 96 h to obtain a catalyst skeleton III.

30 g of the catalyst skeleton III was leached with 235 mL of ethyl acetate at low temperature (5° C.) at a stirring speed of 1,000 rpm for 15 s, and a resulting material was subjected to vacuum filtration to obtain a filter cake, and the filter cake was washed 3 times with cold ethyl acetate at low temperature. The leaching was repeated 3 times to remove the nanosphere hard template I to obtain a catalyst precursor IV without the nanosphere hard template I.

8 g of the catalyst precursor IV, 240 mL of methyl isobutyl ketone, and 5 g of tetrabutoxy zirconium were added to a device equipped with an inert gas protection system and a stirrer, and subjected to a reaction while stirring at 70° C. for 36 h. A resulting reaction product was subjected to vacuum filtration to obtain a filter cake, and the filter cake was dried, then hydrolyzed at a stirring speed of 1,000 rpm for 3 h, and then a resulting hydrolyzed product was subjected to vacuum filtration and then drying for 6 h to obtain a powder precursor V.

The powder precursor V was impregnated with 2 mol/L of an ammonium persulfate solution at room temperature at a stirring speed of 800 rpm for 4 h. A resulting system was subjected to vacuum filtration to obtain a filter cake, and the filter cake was subjected to vacuum drying at 90° C. for 4 h, and then calcined at 500° C. for 8 h to remove the soft template therein to obtain an MCM-type mesoporous molecular sieve-based solid acid-base catalyst of “mesoporous MgO-macroporous ZrO₂/S₂O₈²⁻”.

The remaining steps were the same as those in Example 1.

### Comparative Example 1

A polymer monomer 1-ethylene-4-(2-methylpropyl)benzene after removing a polymerization inhibitor, and pure water were mixed to obtain a 1-ethylene-4-(2-methylpropyl)benzene aqueous solution (11.1%, w/w). 900 g (11.1%, w/w) of the 1-ethylene-4-(2-methylpropyl)benzene aqueous solution was added to a reaction device equipped with an inert gas protection system and a stirrer, and an initiator (H₂O₂-vitamin C redox system) was added dropwise thereto while stirring (at 600 rpm) a resulting mixture at 70° C., where amounts of the dropwise addition of H₂O₂ and vitamin C were 2% and 0.5% of a mass of the polymer monomer, respectively, and the dropwise addition was conducted for a total of 50 min. After the initiator was added dropwise, the stirring speed was adjusted to 300 rpm. After forming a polymer nanosphere, a resulting system was stirred continually for 12 h, and then subjected to high-speed centrifugation at 20,000 rpm, washing 3 times and vacuum drying at 100° C. to obtain a nanosphere hard template I*.

15.2 g of a soft template long-chain alkyl secondary alcohol polyoxyethylene ether CₘH₂ₘ₊₁O(C₂H₄O)ₙH (where m=11-15, n=30), 20.4 g of Mg(NO₃)₂·6H₂O, and 45 mL of TMOS were added to 90 g of pure water. A resulting mixture was put into a stirring mixer, and mixed by stirring at 45° C. and 1,000 rpm for 60 min to obtain a precursor II*.

20 g of the nanosphere hard template I* and 50 g of the precursor II* were mixed, and stirred for 20 min to achieve homogenization. A resulting material was subjected to rotary evaporation to remove hydrolyzed small-molecule products, and a resulting residual product was subjected to gelation aging in air at room temperature for 72 h to obtain a catalyst skeleton III*.

30 g of the catalyst skeleton III* was leached with 178 mL of toluene at low temperature (−3° C.) at a stirring speed of 800 rpm for 20 s, and a resulting material was subjected to vacuum filtration to obtain a filter cake, and the filter cake was washed 3 times with cold toluene at low temperature. The leaching was repeated 3 times to remove the nanosphere hard template I to obtain a catalyst precursor IV without the nanosphere hard template I*. The precursor IV* was subjected to vacuum drying at 90° C. for 4 h, and then calcined at 400° C. for 6 h to remove the soft template therein to obtain an MCM-type solid base catalyst of “mesoporous MgO-macropores unmodified”. The remaining steps were the same as those in Example 1.

### Comparative Example 2

A polymer monomer 1-ethylene-4-(2-methylpropyl)benzene after removing a polymerization inhibitor, and pure water were mixed to obtain a 1-ethylene-4-(2-methylpropyl)benzene aqueous solution (11.1%, w/w). 900 g (11.1%, w/w) of the 1-ethylene-4-(2-methylpropyl)benzene aqueous solution was added to a reaction device equipped with an inert gas protection system and a stirrer, and an initiator (H₂O₂-vitamin C redox system) was added dropwise thereto while stirring (at 600 rpm) a resulting mixture at 70° C., where amounts of the dropwise addition of H₂O₂ and vitamin C were 2% and 0.5% of a mass of the polymer monomer, respectively, and the dropwise addition was conducted for a total of 50 min. After the initiator was added dropwise, the stirring speed was adjusted to 300 rpm. After forming a polymer nanosphere, a resulting system was stirred continually for 12 h, and then subjected to high-speed centrifugation at 20,000 rpm, washing 3 times, and vacuum drying at 100° C. to obtain a nanosphere hard template I^{#}.

15.2 g of a soft template long-chain alkyl secondary alcohol polyoxyethylene ether CₘH₂ₘ₊₁O(C₂H₄O)ₙH (where m=11 to 15, n=30) and 45 mL of TMOS were added to 90 g of pure water. A resulting mixture was put into a stirring mixer, and mixed by stirring at 45° C. and 1,000 rpm for 60 min to obtain a precursor II #.

20 g of the nanosphere hard template I^{#} and 50 g of the precursor II^{#} were mixed, and stirred for 20 min to achieve homogenization. A resulting material was subjected to rotary evaporation to remove hydrolyzed small-molecule products, and a resulting residual product was subjected to gelation aging in air at room temperature for 72 h to obtain a catalyst skeleton III #.

30 g of the catalyst skeleton III^{#} was leached with 178 mL of toluene at low temperature (−3° C.) at a stirring speed of 800 rpm for 20 s, and a resulting material was subjected to vacuum filtration to obtain a filter cake, and the filter cake was washed 3 times with cold toluene at low temperature. The leaching was repeated 3 times to remove the nanosphere hard template I to obtain a catalyst precursor IV without the nanosphere hard template I #.

8 g of the catalyst precursor IV #, 198 mL of n-butanol, and 4 g of tetrabutoxyzirconium were added to a device equipped with an inert gas protection system and a stirrer, and subjected to a reaction while stirring at 80° C. for 24 h. A resulting reaction product was subjected to vacuum filtration to obtain a filter cake, and the filter cake was dried, then hydrolyzed at a stirring speed of 800 rpm for 4 h, and then a resulting hydrolyzed product was subjected to vacuum filtration and then drying for 6 h to obtain a powder precursor V #.

The powder precursor V^{#} was impregnated with 1.5 mol/L of an ammonium persulfate solution at room temperature at a stirring speed of 1,000 rpm for 8 h. A resulting system was subjected to vacuum filtration to obtain a filter cake, and the filter cake was subjected to vacuum drying at 90° C. for 4 h, and then calcined at 400° C. for 6 h to remove the soft template therein to obtain an MCM-type macroporous solid acid catalyst of “mesopores unmodified—macroporous ZrO₂/S₂O₈²⁻”.

The remaining steps were the same as those in Example 1.

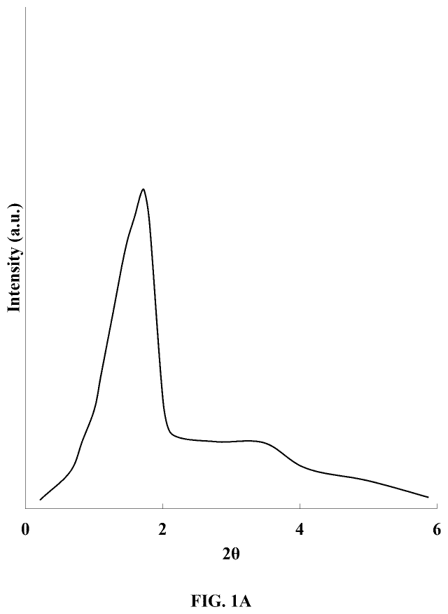

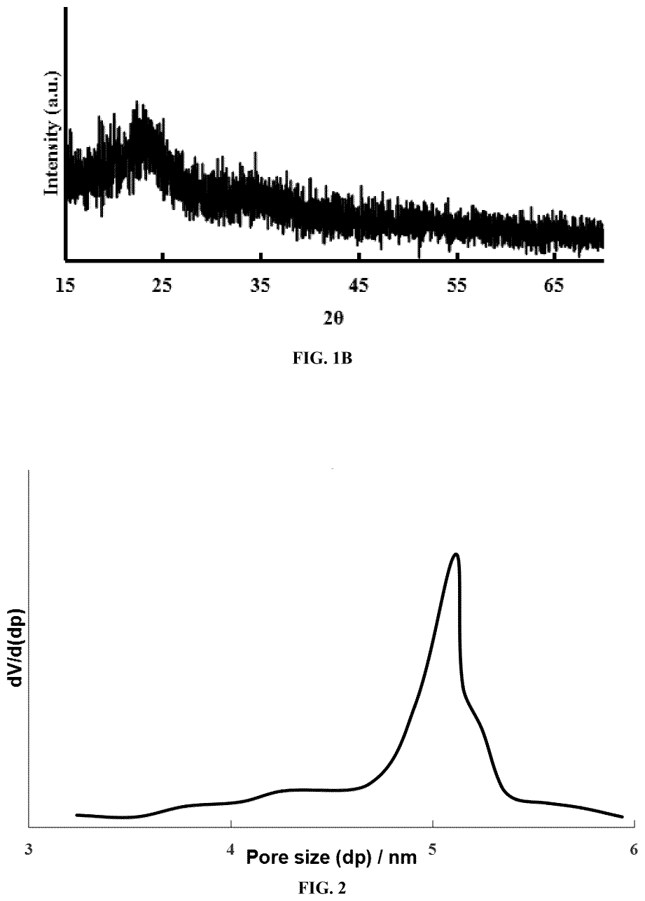

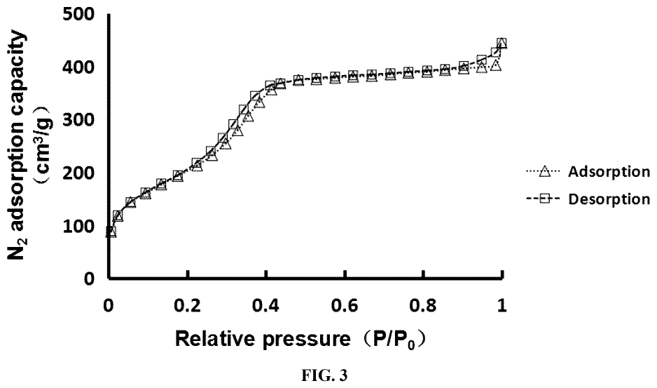

In the present disclosure, the specific surface area (BET) and pore structure (mercury intrusion) data of the catalysts prepared in Examples 1 to 3 and Comparative Examples 1 to 2 are shown in Table 2, FIG. 2, and FIG. 3; the XRD crystal phase information is shown in FIG. 1A to FIG. 1B; and the element content analysis and the acidic and basic site loading capacities (titration analysis) data are shown in Table 3.

Table 2 Specific surface area (SSA) and pore structure parameters of catalysts in Examples 1 to 3 and Comparative Examples 1 to 2

| | | Total pore | Mesopore | Mesopore | Macropore | Macropore |
|---|---|---|---|---|---|---|
| | SSA | volume | volume | diameter | volume | diameter |
| Catalyst SN | (m²/g) | (cm³/g) | (cm³/g) | (nm) | (cm³/g) | (nm) |
| Example 1 | 682 | 0.7 | 0.3 | 5.1 | 0.4 | 50-360 |
| Example 2 | 626 | 0.6 | 0.2 | 4.2 | 0.4 | 50-360 |
| Example 3 | 728 | 0.7 | 0.3 | 4.3 | 0.4 | 50-400 |
| Comparative | 695 | 0.7 | 0.3 | 5.1 | 0.4 | 50-370 |
| Example 1 | | | | | | |
| Comparative | 703 | 0.7 | 0.3 | 5.1 | 0.4 | 50-380 |
| Example 2 | | | | | | |

Table 3 Active element ratio and active site loading capacities of catalysts in Examples 1 to 3 and Comparative Examples 1 to 2

| | | Active site loading | |
|---|---|---|---|
| | Active element | capacity (μmol/g) | |
| Catalyst SN | ratio (wt %) | Basic site | Acidic site |
| Example 1 | Mg:1.55; Zr:1.86; S:1.06 | 78 | 152 |
| Example 2 | Ca:1.31; Ti:1.80; S:0.97 | 60 | 145 |
| Example 3 | Mg:1.43; Zr:1.95; S:1.05 | 71 | 157 |
| Comparative | Mg:1.65 | 92 | — |
| Example 1 | | | |
| Comparative | Zr:1.94; S:1.14 | — | 166 |
| Example 2 | | | |

As shown in the data in Table 2, the MCM-type mesoporous molecular sieve-based solid acid-base catalysts synthesized in the present disclosure have a large number of mesopores and macropores, and the specific surface areas are extremely high, meeting the basic requirements for excellent catalytic performance.

As shown in the data in Table 3, the catalyst synthesized in Comparative Example 1 only has basic sites for catalyzing transesterification, and the catalyst prepared in Comparative Example 2 only has acidic sites for catalyzing esterification.

The catalyst synthesized in Example 1 is tested and characterized, and the results are shown in FIG. 1A to FIG. 1B, FIG. 2, and FIG. 3.

As shown in FIG. 1A, the characteristic peak of the (100) crystal plane of the MCM mesoporous material appears in the small-angle XRD pattern, which is located near the diffraction angle of 1.7°, indicating that a catalyst with an MCM mesoporous channel structure has been successfully prepared.

As shown in FIG. 1B, the wide-angle XRD pattern does not show the characteristic peaks of the crystalline phase of magnesium and zirconium compounds, indicating that the magnesium and zirconium in the synthesized catalyst exist in a highly dispersed amorphous state.

As shown in FIG. 2, the mesopore size data on the pore size distribution reflect the typical MCM mesopore characteristics, which are consistent with those in Table 2

The catalyst prepared in Example 1 was subjected to N₂ physical adsorption-desorption experiments, and a type IV adsorption-desorption isotherm curve with an H1 type hysteresis loop was obtained (FIG. 3). This is a typical feature of MCM-type mesoporous materials with relatively narrow pore size distribution, once again proving that a mesoporous structure is indeed prepared in the catalyst of the present disclosure.

### Example 4

30 g of cottonseed oil II, 250 mL of isotridecanol, and 3.9 g of the catalyst (the MCM-type mesoporous molecular sieve-based solid acid-base catalyst of “mesoporous MgO-macroporous ZrO₂/S₂O₈²⁻” prepared in Example 1) were added to a reactive distillation test device, and a resulting mixture was heated to 105° C. while stirring (at 800-1000 rpm). A certain vacuum degree was maintained in the device and water generated by an esterification reaction was separated out in time. After 4 h of the reaction, the catalyst was removed by filtration, and a resulting filtrate was stood and layered, where an upper layer mainly included fatty acid isotridecyl ester, isotridecanol, and trace oleic acid, and a lower layer mainly included glycerol, isotridecanol, and trace water. The isotridecanol in the upper oil phase was recovered by molecular distillation, and the fatty acid isotridecyl ester product was refined by unit operations, such as alkali refining, water washing, adsorption decolorization, filtration, and water removal.

### Comparative Example 3

The catalyst was the MCM-type solid base catalyst of “mesoporous MgO-macropores unmodified” prepared in Comparative Example 1, and the other steps were the same as those in Example 4.

### Comparative Example 4

The catalyst was the MCM-type macroporous solid acid catalyst of “mesopores unmodified—macroporous ZrO₂/S₂O₈²⁻” prepared in Comparative Example 2, and the other steps were the same as those in Example 4.

Table 4 Comparison of catalytic performance of cottonseed oil transesterification and esterification in Example 1, Example 4, and Comparative Examples 1 to 4

| | Acid value of crude | Cottonseed oil | Oleic acid |
|---|---|---|---|
| | fatty acid ester | conversion rate | conversion rate |
| SN | (4 h, mgKOH/g) | (4 h, %) | (4 h, %) |
| Example 1 | 0.06 | 97.5 | — |
| Comparative | 0.57 | 97.2 | — |
| Example 1 | | | |
| Comparative | 0.07 | 7.2 | — |
| Example 2 | | | |
| Example 4 | 0.80 | 95.8 | 96.0 |
| Comparative | 28.5 | 12.3 | 5.4 |
| Example 3 | | | |
| Comparative | 0.79 | 5.9 | 97.3 |
| Example 4 | | | |

It can be seen from Table 4 that:

(1) When the raw material is the low acid value cottonseed oil I, the cottonseed oil transesterification conversion rates of Comparative Example 1 and Example 1 are equivalent, 97.2% and 97.5%, respectively, indicating that the catalytic performance of the solid base catalyst synthesized in Comparative Example 1 for transesterification is comparable to that of the MCM-type solid acid-base catalyst of “mesoporous MgO-macroporous ZrO₂/S₂O₈²⁻” synthesized in Example 1. However, the transesterification conversion rate of the cottonseed oil in Comparative Example 2 is only 7.2%, showing very poor performance, indicating that the basic sites have excellent catalytic activity for transesterification.

(2) When the raw material is the high acid value cottonseed oil II, the transesterification conversion rate of Example 4 is 95.8%, which is very close to 97.5% of Example 1. Moreover, the oleic acid esterification conversion rate also reaches 96.0%, and the catalytic activity for transesterification and esterification comes from the basic and acidic sites in the catalyst, respectively. The presence of free oleic acid in cottonseed oil II does not affect the catalytic activity of the catalyst for transesterification (i.e., the free oleic acid molecules do not cause the deactivation of the basic sites), which is closely related to the topological structure of the prepared MCM-type solid acid-base catalyst. The basic and acidic sites in the catalyst are confined and separated from each other in space, and are located in the MCM mesopores and the surface macropores, respectively.

(3) The transesterification conversion rate of the high acid value cottonseed oil II in Comparative Example 3 is only 12.3%, which is much lower than the transesterification conversion rate of the low acid value cottonseed oil I in Comparative Example 1 (97.2%). This is because the macroporous structure on the surface of the solid base catalyst has not been acid-treated, namely there are no acidic active sites required for the esterification, and the free oleic acid could not be esterified. When the free oleic acid diffuses into the mesoporous channels of the MCM, it may occupy the active basic sites therein, resulting in catalyst poisoning.

(4) A surface macroporous solid acid catalyst is used in Comparative Example 4, which has a desirable catalytic effect on the esterification of the free oleic acid, with an esterification conversion rate of up to 97.3%. However, since there are no basic sites in the mesopores, the catalytic conversion rate for the transesterification is only 5.9%.

A low pour point cottonseed oil separated by freezing operation is blended with the refined fatty acid isotridecyl ester product synthesized in Example 4, and then 0.3% of butylated hydroxytoluene, 0.2% of methylbenzotriazole, and 1% of polyalphaolefin are added thereto to prepare a cottonseed insulating oil. The physical, chemical, and electrical performance parameters of cottonseed insulating oil evaluated according to general standards are listed in Table 5. Table 5 Performance parameters of cottonseed insulating oil

| | | | Cottonseed insulating |
|---|---|---|---|
| | | | oil prepared in the |
| Characteristic parameter | Test method | ASTM D6871 | present disclosure |

Electrical performance

| Breakdown voltage (kV/2.5 mm) | | | IEC 156 | ≥35 | 70 |
|---|---|---|---|---|---|
| Dielectric loss factor | 25° | C. | ASTM D924 | ≤0.2 | 0.04 |
| | 100° | C. | ASTM D924 | ≤4 | 1.32 |

Physical and chemical performances

| Relative density (g · cm⁻³@15° C.) | | | ASTM D1298 | ≤0.96 | 0.95 |
|---|---|---|---|---|---|
| Chromaticity/No. | | | ASTM D1500 | ≤1.0 | 0.3 |
| Acid value (mg · KOH/g) | | | ASTM D974 | ≤0.06 | 0.02 |
| Kinematic viscosity | 40° | C. | GB/T 265 | ≤50 | 36.8 |
| (mm²/s) | 100° | C. | GB/T 265 | ≤15 | 6.4 |

| | | | |
|---|---|---|---|
| Flash point (open)/° C. | GB/T 3536 | ≥275 | 302 |
| Ignition point/° C. | GB/T 3536 | ≥300 | 330 |
| Pour point/° C. | GB/T 3536 | ≤−10 | −37 |

As shown in Table 5, the cottonseed insulating oil prepared in the present disclosure has excellent indicators, among which the breakdown voltage (70 kV, 2.5 mm), flash point (302° C.), and ignition point (330° C.) are far better than those of mineral oil, showing a high safety during use. In addition, the low-temperature performance is also excellent (a pour point of −37° C.).

### Catalyst Performance Decay Experiment:

1. The catalyst in Example 1 was filtered off and recovered. A recovered catalyst was vacuum-dried at 100° C. for 4 h, and then subjected to a catalytic reaction according to the operating conditions of Example 1. The above steps were repeated 6 times. The transesterification conversion rate of cottonseed oil decreased to 81.5%.

2. The catalyst in Example 1 was filtered off and recovered. A recovered catalyst was washed 3 times with acetone and then vacuum-dried at 100° C. for 4 h, and then subjected to a catalytic reaction according to the operating conditions of Example 1. The above steps were repeated 6 times. The transesterification conversion rate of cottonseed oil decreased to 90.6%. After repeating the above steps for 6 times, the recovered catalyst was calcined at 400° C. for 10 min in air, cooled to room temperature, and then subjected to a catalytic reaction according to the operating conditions of Example 1. The transesterification conversion rate of cottonseed oil became 95.4%.

3. The catalyst in Example 4 was filtered off and recovered. A recovered catalyst was vacuum-dried at 100° C. for 4 h, and then subjected to a catalytic reaction according to the operating conditions of Example 4. The above steps were repeated 6 times. The transesterification conversion rate and oleic acid conversion rate of the cottonseed oil were reduced to 78.6% and 79.2%, respectively.

4. The catalyst in Example 4 was filtered off and recovered. A recovered catalyst was washed 3 times with acetone and then vacuum-dried at 100° C. for 4 h, and then subjected to a catalytic reaction according to the operating conditions of Example 4. The above steps were repeated 6 times. The transesterification conversion rate and oleic acid conversion rate of the cottonseed oil were reduced to 89.3% and 90.5%, respectively. After repeating the above steps for 6 times, the recovered catalyst was calcined at 400° C. for 10 min in air, cooled to room temperature, and then subjected to a catalytic reaction according to the operating conditions of Example 4. The transesterification conversion rate and oleic acid conversion rate of cottonseed oil became 94.2% and 93.7%, respectively.

In the present disclosure, the results of the catalyst performance decay experiment show that the synthesised MCM-type mesoporous molecular sieve-based solid acid-base catalyst could still maintain excellent catalytic performance during repeated use, and the catalytic performance could be better restored by acetone washing. With the aid of short-time air calcination, the catalytic performance is almost equivalent to that of the initial catalyst.

Although the present disclosure is described in detail with reference with the foregoing examples, they are only a part of, not all of, the examples of the present disclosure. Other examples can be obtained based on these examples without creative efforts, and all of these examples shall fall within the scope of the present disclosure.

1. A method for preparing a mesoporous molecular sieve-based solid acid-base catalyst, comprising:
(1) synthesizing a hard template
mixing a polymer monomer and a first pure water to obtain a polymer monomer aqueous solution, subjecting the polymer monomer aqueous solution and an initiator to a first reaction while stirring under protection of an inert gas to obtain a nanosphere, and washing and drying the nanosphere to obtain a nanosphere hard template I;
(2) preparing a catalyst skeleton
stirring a soft template, a nitrate, a silane derivative, and a second pure water to obtain a precursor II, mixing the nanosphere hard template I and the precursor II, and subjecting a resulting material to aging to obtain a catalyst skeleton III;
(3) preparing a precursor
leaching the catalyst skeleton III with a solvent to remove the nanosphere hard template I to obtain a catalyst precursor IV without the nanosphere hard template I, subjecting the catalyst precursor IV, an organic solvent, and a transition metal alkoxy compound to a second reaction while stirring under protection of an inert gas, subjecting a resulting reaction product to first vacuum filtration to obtain a filter cake, drying the filter cake, then hydrolysing, and then subjecting a resulting hydrolysied product to second vacuum filtration and first drying to obtain a powder precursor V; and
(4) preparing the mesoporous molecular sieve-based solid acid-base catalyst
impregnating the powder precursor V with an ammonium persulfate solution, and subjecting a resulting system to third vacuum filtration, second drying, and calcination in sequence to obtain the mesoporous molecular sieve-based solid acid-base catalyst.

2. The method of claim 1, wherein in step (1), raw materials of the nanosphere hard template I further comprise a modified dispersant,
the modified dispersant is 2-acrylamide-2-methylpropanesulfonic acid, and
a dosage of the modified dispersant is 0% to 1% of a total mass of the polymer monomer.

3. The method of claim 1, wherein in step (2), raw materials of the precursor II further comprise a pore expanding agent,
the pore expanding agent is one or two selected from the group consisting of mesitylene, a straight-chain alkane, and tert-amyl alcohol, and
a molar ratio of the pore expanding agent to the soft template is in a range of 0:1 to 1:1.

4. The method of claim 1, wherein in step (1), the polymer monomer is one or two selected from the group consisting of 4-methylstyrene, 1-ethylene-4-(2-methylpropyl)benzene, 4-tert-butylstyrene, and vinyl acetate.

5. (canceled)

6. The method of claim 1, wherein in step (1),
the initiator is selected from the group consisting of a single initiator and a redox composite initiator;
the single initiator is selected from the group consisting of H₂O₂, ammonium persulfate, and potassium persulfate;
the redox composite initiator is selected from the group consisting of a persulfate-sodium sulfite system composite initiator, a persulfate-sodium bisulfite system composite initiator, a persulfate-sodium dithionate system composite initiator, a persulfate-vitamin C system composite initiator, a H₂O₂-sodium sulfite system composite initiator, a H₂O₂-sodium bisulfite system composite initiator, a H₂O₂-sodium dithionate system composite initiator, and a H₂O₂-vitamin C system composite initiator; and
a persulfate in the redox composite initiator is selected from the group consisting of the ammonium persulfate and the potassium persulfate.

7. The method of claim 1, wherein in step (1),
a mass ratio of the polymer monomer to the first pure water is in a range of 1:5 to 1:9; and
a dosage of the initiator is 0.5% to 6% of a total mass of the polymer monomer.

8. (canceled)

9. The method of claim 1, wherein in step (1),
the first reaction under the stirring is conducted at a temperature of 50° C. to 80° C., and
the washing is conducted 3 to 4 times, and the drying is conducted at a temperature of 80° C. to 100° C.

10. The method of claim 1, wherein in step (2), the soft template is a polyoxyethylene nonionic surfactant; and the polyoxyethylene nonionic surfactant is one or two selected from the group consisting of a long-chain alkyl secondary alcohol polyoxyethylene ether series surfactant and an alkyl aryl polyoxyethylene ether series surfactant.

11. The method of claim 1, wherein in step (2), the nitrate is one or more selected from the group consisting of a Group II metal nitrate and a rare earth metal nitrate; and the silane derivative is one or more selected from the group consisting of tetramethoxysilane (TMOS), tetraethoxysilane (TEOS), tetrapropoxysilane (TPOS), and tetrabutoxysilane (TBOS).

12. (canceled)

13. (canceled)

14. The method of claim 1, wherein in step (2), a molar ratio of the soft template, the nitrate, the silane derivative, and the second pure water is in a range of 1:2-8:14-31: 400-500.

15. The method of claim 1, wherein in step (2),
the stirring is conducted at room temperature to 55° C. for 15 minutes to 60 minutes with a stirring speed of 800 rpm (revolutions per minute) to 1,200 rpm, and
the mixing is conducted for 20 minutes to 30 minutes, and the aging is conducted for 36 hours to 96 hours.

16. The method of claim 1, wherein in step (2), a mass ratio of the nanosphere hard template I to the precursor II is in a range of 2:3 to 2:5.

17. (canceled)

18. The method of claim 1, wherein in step (3),
the solvent is selected from the group consisting of methyl ethyl ketone, ethyl acetate, and toluene, and
a mass ratio of the catalyst skeleton III to the solvent is in a range of 1:5 to 1:8.

19. (canceled)

20. The method of claim 1, wherein in step (3), the leaching is conducted at a temperature of −3° C. to 5° C. for 15 seconds to 30 seconds.

21. The method of claim 1, wherein in step (3),
the organic solvent is selected from the group consisting of isooctane, heptane, isobutanol, n-butanol, butyl acetate, toluene, p-xylene, propanol, and methyl isobutyl ketone;
the transition metal alkoxy compound is selected from the group consisting of a zirconium alkoxy compound, a titanium alkoxy compound, and a hafnium alkoxy compound; and
an alkoxy in the transition metal alkoxy compound is selected from the group consisting of tetraethoxy, tetrapropoxy, tetraisopropoxy, and tetrabutoxy.

22. The method of claim 1, wherein in step (3), a mass ratio of the catalyst precursor IV to the organic solvent is in a range of 1:14 to 1:24, and a mass ratio of the transition metal alkoxy compound to the catalyst precursor IV is in a range of 1:1 to 1:2.

23. The method of claim 1, wherein in step (3), the second reaction while the stirring is conducted at a temperature of 60° C. to 80° C. for 24 hours to 36 hours.

24. The method of claim 1, wherein in step (4),
the ammonium persulfate solution has a concentration of 1 mol/L (mole/Litre) to 2 mol/L, and
the impregnating is conducted for 4 hours to 8 hours, and the calcination is conducted at a temperature of 400° C. to 600° C. for 4 hours to 8 hours.

25. (canceled)

26. (canceled)

27. A mesoporous molecular sieve-based solid acid-base catalyst prepared by the method of claim 1, wherein the mesoporous molecular sieve-based solid acid-base catalyst is a topological structure in which macropores and mesopores are interconnected; the macropores are located on a surface of the mesoporous molecular sieve-based solid acid-base catalyst, and the mesopores are located inside the mesoporous molecular sieve-based solid acid-base catalyst; an acidic site exists in the macropores, and a basic site exists in the mesopores; and the acidic site and the basic site are confined and separated from each other in space.

28. A method for using a mesoporous molecular sieve-based solid acid-base catalyst in synthesis of an insulating oil for a transformer, comprising:
using the mesoporous molecular sieve-based solid acid-base catalyst of claim 27 in the synthesis of the insulating oil for the transformer by the transesterification of the cottonseed oil, and then subjecting a resulting catalyst to recycling;
wherein the recycling is conducted by a process comprising: filtering the insulating oil for the transformer by the transesterification of the cottonseed oil to obtain the mesoporous molecular sieve-based solid acid-base catalyst, then washing the mesoporous molecular sieve-based solid acid-base catalyst with acetone, and then subjecting a washed mesoporous molecular sieve-based solid acid-base catalyst to vacuum drying, calcination with air, and cooling in sequence.

29. (canceled)
